(19) United States
(12) Patent Application Publication
(10) Pub. No.: US 2009/0305007 A1
(43) Pub. Date: Dec. 10, 2009

(54) SHELL FOR PORTABLE ELECTRONIC DEVICE AND METHOD FOR MAKING SAME

(75) Inventors: YUAN-YI LAI, Tu-Cheng (TW); CHIA-HSIN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/352,655

(22) Filed: Jan. 13, 2009

(30) Foreign Application Priority Data
Jun. 4, 2008 (CN) 200810301964.4

(51) Int. Cl. B32B 3/10; B05D 1/32

(52) U.S. Cl. 428/195.1; 427/282

(57) ABSTRACT

The invention discloses a shell for portable electronic devices which includes a main body and an opaque ink layer. The main body is made of translucent material and includes an outer surface and an inner surface opposite to the outer surface. The opaque ink layer is coated on the inner surface of the main body except for a design area on the inner surface of the main body. Through masking, the design area may incorporate any desired decorative pattern such as a logo, a call id pattern, a message prompt pattern, a charging pattern or some other design. The design area is an area surrounded by the opaque ink layer and the inner surface is exposed through the design area. The invention also discloses a method for making the shell.

### BACKGROUND

1. Technical Field

The exemplary disclosure generally relates to a shell for portable electronic device and a method for making the same.

2. Discussion of the Related Art

With the development of wireless communication and information processing technologies, sliding portable electronic devices such as mobile phones and personal digital assistants (PDAs) are now in widespread use, and consumers may now enjoy the full convenience of high technology products almost anytime and anywhere. In order to satisfy consumers' demands, more and more portable electronic devices employ shells with symbols.

Referring to FIG. 3 and FIG. 4, a conventional shell 10, according to the prior art, with design area such as that used for a company logo is substantially rectangular in shape, and includes a main body 11, an opaque ink layer 13 and a translucent ink layer 15. The main body 11 is a substantially rectangular transparent board and includes an outer surface 111 and an inner surface 112 opposite the outer surface 111. The opaque ink layer 13 is coated on the inner surface 112 of the main body 11 beside a design area 133. The translucent ink layer 15 is attached on the opaque ink layer 13 to sandwich the opaque ink layer 13 between the translucent ink layer 15 and the main body 11.

The conventional manufacturing method for the shell 10 with design area includes the following steps: providing a main body 11 made of transparent material, and shading a pre-design area on the inner surface 112 of the main body 11; coating an opaque ink layer 13 on the inner surface 112, and then removing the material of the opaque area on the main body 11 to form the design area 133; and coating a translucent ink layer 15 on the opaque ink layer 13 to get the shell 10 with design area. However, the design area will often suffer an orange peel effect during the conventional manufacturing process of the shell 10 that influences the transmittance, the productivity and the usability of the shell 10 greatly.

### BRIEF DESCRIPTION OF THE DRAWING

Many aspects of the present shell for portable electronic devices and method for making same can be better understood with reference to the following drawings. The components in the drawings are not necessarily drawn to scale, the emphasis instead being placed upon clearly illustrating the principles of the present shell and the method for making the shell. Moreover, in the drawings, like reference numerals designate corresponding parts throughout the several views.

FIG. 1 is a schematic, perspective view of the shell with a design area for portable electronic devices and method for making same, according to an exemplary embodiment.

FIG. 2 shows a disassembled, perspective view of the shell of FIG. 1.

FIG. 3 shows a schematic, perspective view of a conventional shell with a design area according to the prior art.

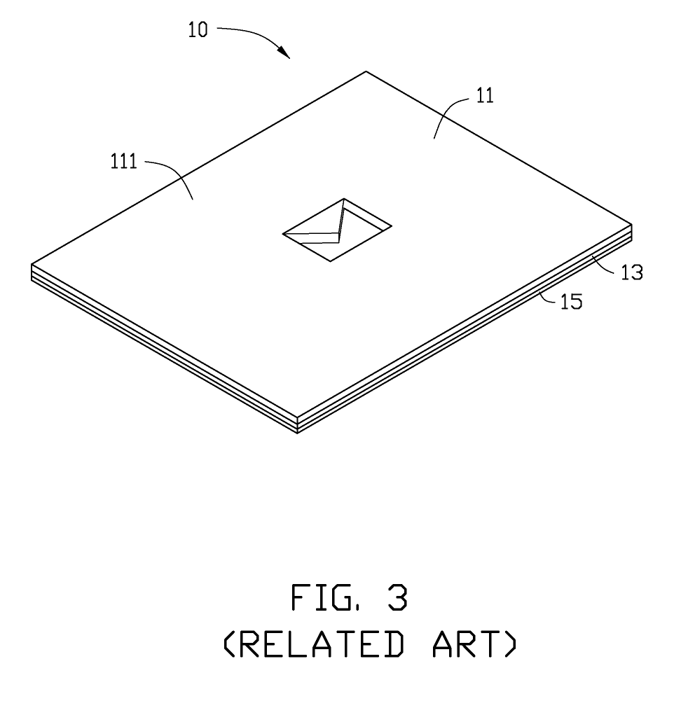

FIG. 4 shows a disassembled perspective view of the shell of FIG. 3, according to the prior art.

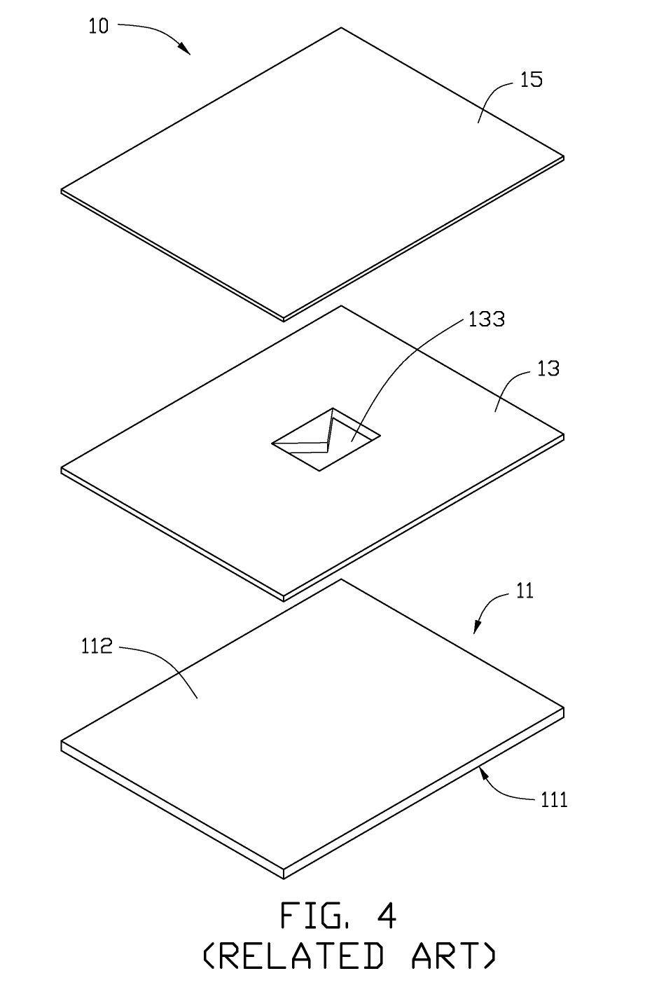

### DETAILED DESCRIPTION OF THE EMBODIMENT

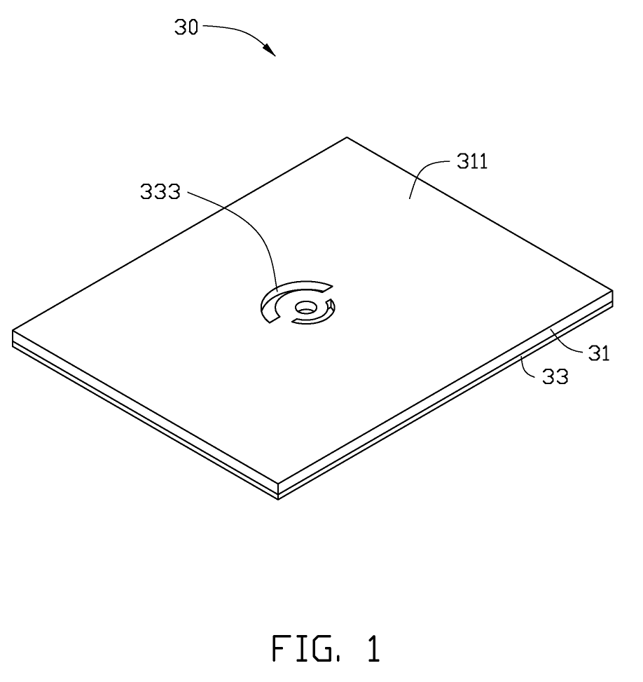

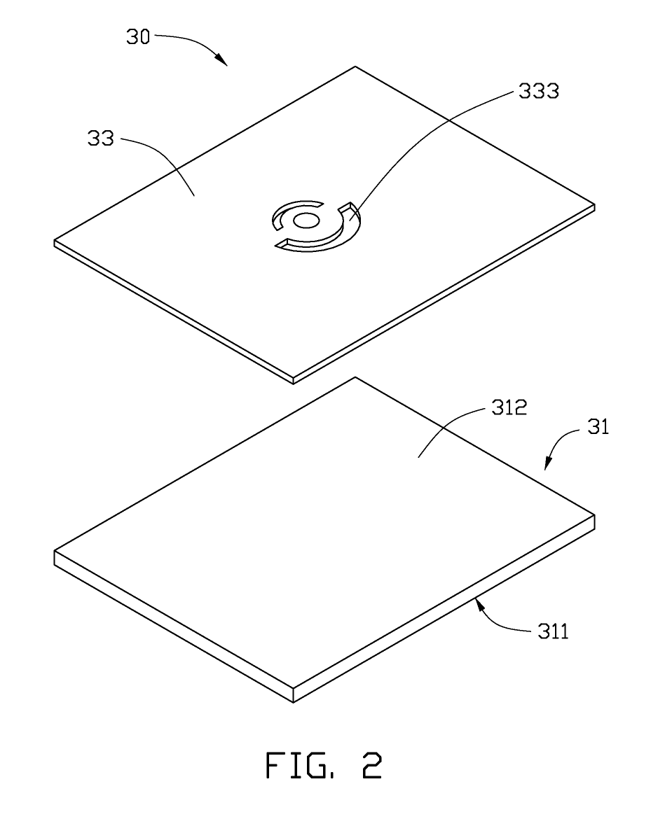

Referring now to FIG. 1 and FIG. 2, the shell 30 with a design area has a multiple layer structure, and includes a main body 31 and an opaque ink layer 33. The main body 31 is a substantially rectangular board made of translucent material, such as polycarbonate plastic. The main body 31 includes two opposite surfaces, e.g., an outer surface 311 and an inner surface 312. The opaque ink layer 33 is coated on the inner surface 312 of the main body 31 except for the design area 333 on the inner surface 312. That is, the design area 333 is an area surrounded by the opaque ink layer 33, and the inner surface 312 is exposed through the opaque ink layer 33 through the design area 333. Through masking, the design area 333 may incorporate any desired decorative pattern such as a logo, a call id pattern, a message prompt pattern, a charging pattern or some other design. In use, for example, the shell 30 with design area 333 is mounted on a portable electronic device such as a flip type phone; the design area 333 is aligned with an interior part of the flip type phone with an LED light assembled near under the design area 333 of the shell 30. The LED will turn on when instructed to do so such as when there is an incoming call to notify a user.

A method for manufacturing the shell 30 includes following steps.

Provide a main body 31 made of translucent material and mask a design area 333 on an inner surface 312 of the main body 31.

Coat a layer of opaque ink on the inner surface 312 of the main body 31 to form an opaque ink layer 33 thereon.

Remove the masking material leaving a design area 333 on the inner surface 312 of the main body 31 without opaque ink thereon.

The current method for manufacturing the shell 30 reduces the working procedures of the conventional method and avoids generating the orange peel effect. The current method for manufacturing the shell 30 raises the production efficiency and economizes the production cost.

It is to be understood, however, that even though numerous characteristics and advantages of the present invention have been set forth in the foregoing description, with details of the structure and function of the present invention, the disclosure is illustrative only, and changes may be made in detail, especially in matters of shape, size, and arrangement of parts within the principles of present invention to the full extent indicated by the broad general meaning of the terms in which the appended claims are expressed.

1. A shell for portable electronic devices comprising:
a main body made of translucent material comprising an outer surface and an inner surface opposite the outer surface; and
an opaque ink layer coated on the inner surface of the main body except for a design area on the inner surface, the design area comprises of an area surrounded by the opaque ink layer and the inner surface is exposed through the design area.

2. The shell for portable electronic devices as claimed in claim 1, wherein the main body is rectangular board and made of polycarbonate plastic material.

3. The shell for portable electronic devices as claimed in claim 2, wherein the design area comprises at least one of a group consisting of a logo, a call id pattern, a message prompt pattern and a charging pattern.

4. The method for making the shell comprising following steps:
providing a main body made of translucent material and masking a pre-design area by a masking material on an inner surface of the main body;
coating a layer of opaque ink on the inner surface of the main body to form an opaque ink layer thereon;
removing the masking material to form a design area on the inner surface of the main body without opaque ink thereon.

5. The method for making the shell as claimed in claim 4, wherein the main body is made of polycarbonate plastic material.

6. The method for making the shell as claimed in claim 5, wherein the design area comprises at least one of a group consisting of a logo, a call id pattern, a message prompt pattern and a charging pattern.
